(19) United States
(12) Patent Application Publication
(10) Pub. No.: US 2007/0063087 A1
(43) Pub. Date: Mar. 22, 2007

(54) Rotation detecting method and apparatus and photo film retention detecting method and apparatus

(75) Inventors: Akio Suto, Kanagawa (JP); Ikuhisa Sato, Kanagawa (JP); Yukio Nakano, Kanagawa (JP); Takayuki Abe, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/495,783

(22) Filed: Jul. 31, 2006

(30) Foreign Application Priority Data
Jul. 29, 2005 (JP) 2005-220501

(51) Int. Cl. G03C 3/00; B65H 18/10

(52) U.S. Cl. 242/348.4; 242/532.7; 250/206.1

(57) ABSTRACT

A rotation detecting apparatus for use in producing a photo film cassette has an opaque detecting dog device secured in a manner rotatable together with a rotatable inserter. A light source device applies collimated light flux to the detecting dog device. A detection hole is formed through the detecting dog device, for receiving application of the collimated light flux, and passing light through the detection hole when openings at ends thereof are aligned with one another in a direction of the collimated light flux. A photo receptor receives the passed light passed through the detection hole, and outputs a detection signal according to an amount of the received passed light. In the retention, a trailer of photo film is picked up by the inserter. The inserter is rotationally inserted through a passageway of the photo film cassette. The trailer is fastened on a trailer fastener of a spool.

### BACKGROUND OF THE INVENTION

1. Field of the Invention

The present invention relates to a rotation detecting method and apparatus and photo film retention detecting method and apparatus. More particularly, the present invention relates to a rotation detecting method and apparatus, and photo film retention detecting method and apparatus, in which a rotatable target object which may be a rotatable inserter can be detected precisely, and a photo film cassette can be produced with high efficiency.

2. Description Related to the Prior Art

A photo film cassette Is known in the art of photography, and has a light-tight cassette shell and a spool for winding photo film in a roll form and contained in the cassette shell. In IX 240 type of photo film cassette, the entire strip of the photo film inclusive of its leader is contained in the cassette shell. The leader is advanced to the outside when the spool is rotated in an unwinding direction. In the production of IX 240 type, the trailer of the photo film is inserted into a passageway of the cassette shell by use of the cassette shell as an intermediate product. The trailer is introduced and fastened on the spool, which is then rotated to wind the photo film in the cassette shell.

An example of photo film winder is disclosed in U.S. Pat. No. 5,573,201 (corresponding to JP-A 6-035123). In FIG. 13, a photo film cassette 2 or cartridge is IX 240 type. Photo film 3 is wound up into the photo film cassette 2. A cassette shell 4 or cartridge shell of the photo film cassette 2 includes a rotatable cassette shatter 6 and a rotatable spool 7. A passageway 5 is opened and closed by the cassette shutter 6. The spool 7 winds the photo film 3 thereabout. A spool core 8 of the spool 7 has a slot 9. To provide the photo film cassette 2 with the photo film 3, the cassette shutter 6 is rotated to open the passageway 5. The spool 7 is rotationally positioned to direct the slot 9 toward the passageway 5.

In the photo film winder, a rotatable inserter 12 as a rotatable target object is rotated. A rear end 12a of the rotatable inserter 12 is inserted through the passageway 5 into the slot 9 of the spool 7. A pickup claw 13 of the rear end 12a is moved to an insertion hole 14 in a trailer of the photo film 3 and advanced in a direction toward the left in the drawing. The photo film 3 with the rear end 12a is inserted in the photo film cassette 2. In FIG. 14A, fastening holes 16 formed in the trailer of the photo film 3 are engaged with a hook shaped trailer fastener 17 disposed in the slot 9, and kept retained. The rotatable inserter 12 is removed from the photo film cassette 2. The spool 7 is rotated in the winding direction, to wind the photo film 3 about the spool core 8.

The photo film 3 is unwound from the photo film cassette 2 while contained in a camera. If the retention of the trailer of the photo film 3 on the spool 7 is unsuitable, the entire strip of the photo film 3 will be advanced from the photo film cassette 2. There is no possibility of winding back of the photo film 3 into the photo film cassette 2. In the above photo film winder, there is inspection of applying tension of the photo film 3 in a direction away from the photo film cassette 2 after retaining operation of the trailer on the spool 7, to test suitability of the retention of the fastening holes 16 on the hook shaped trailer fastener 17.

However, an error is likely to occur in the inspection. Although the fastening holes 16 of the photo film 3 are not engaged with the hook shaped trailer fastener 17 in the photo film winder described above, an erroneous result of success may be obtained in the tension inspection. This is because, as illustrated in FIG. 14B, a ridge with flash 20 of plastic on a parting line is formed on the inside of the slot 9 as a result of injection molding of the spool 7. The fastening holes 16 of the photo film 3 contact and interfere with the ridge with flash 20, to increase the tension in application to the photo film 3. A fastened state of the fastening holes 16 of the photo film 3 on the hook shaped trailer fastener 17 should be checked, but cannot be searched reliably, because the spool core 8 of the spool 7 is invisible as contained in the cassette shell 4.

As a result of research of occurrence of unwanted retention of the ridge with flash 20 with the fastening holes 16 of the photo film 3 in place of the hook shaped trailer fastener 17, it has been found that an amount of insertion of the rotatable inserter 12 in the slot 9 is different from a predetermined amount because of rotational offsetting of the spool 7 or the errors in the size. It is conceivable to measure a rotational amount of the rotatable inserter 12 to estimate an inserting amount of the photo film 3 into the slot 9 in the spool 7, so as to check acceptability in the retention of the fastening holes 16 with the hook shaped trailer fastener 17. However, the use of well-known encoder for the detection is unsuccessful for accuracy in the position because of too low resolving power. If an encoder of a specifically high resolving power is used, the cost of manufacturing the photo film cassette will be exceedingly high.

### SUMMARY OF THE INVENTION

In view of the foregoing problems, an object of the present invention is to provide a rotation detecting method and apparatus and photo film retention detecting method and apparatus, in which a rotatable target object which may be a rotatable inserter can be detected precisely, and a photo film cassette can be produced with high efficiency.

In order to achieve the above and other objects and advantages of this invention, a rotation detecting method includes a step of applying collimated light flux from a light source device to an opaque detecting device secured in a manner rotatable together with a rotatable target object. While the collimated light flux is applied, light of the collimated light flux is passed through a detection hole formed through the detecting device when openings at ends of the detection hole are aligned with one another in a direction of the collimated light flux. The passed light is received on a photo receptor, to output a detection signal according to an amount of the received passed light.

A length of the detection hole in a thickness direction of the detecting device is larger than a width of the openings.

Furthermore, a rotational amount of the rotatable target object is determined according to the detection signal.

A ratio D/L is in a range less than 1/1 and equal to or more than 1/20, where L is the length of the detection hole in the thickness direction of the detecting device, and D is the width of the openings in a rotational direction of the rotatable target object.

Also, a rotation detecting apparatus includes an opaque detecting device secured in a manner rotatable together with a rotatable target object. A light source device applies collimated light flux to the detecting device. A detection hole is formed through the detecting device, for receiving application of the collimated light flux, and for passing light through the detection hole when openings at ends thereof are aligned with one another in a direction of the collimated light flux. A photo receptor receives the passed light passed through the detection hole, and outputs a detection signal according to an amount of the received passed light.

The openings at the ends have respectively first and second widths, and the first width is smaller than the second width and is equal to D.

Furthermore, a rotating amount determiner determines a rotating amount of the rotatable target object according to the detection signal.

The rotating amount determiner determines the rotating amount with the detection signal of a state when an area ratio A2/A1 is 0.1 or more, where A1 is an area of the openings, and A2 is an area of an open region defined by superposing the openings in the illuminating direction of the collimated light flux,

The area of the openings is smaller than an area of a section of the collimated light flux on a perpendicular plane thereof.

In a preferred embodiment, an inner surface of the detection hole is formed to extend along an inner plane that is defined to pass peripheral ends of the openings, or is formed to retreat from the inner plane.

An inner surface of the detection hole is processed by anti-reflection processing optically to prevent reflection.

The collimated light flux and the passed light are infrared.

The rotatable target object is rotated by a rotational driving mechanism for rotating about a rotational axis, and is formed in an arc shape to extend along a cylindrical surface defined about the rotational axis.

The rotational driving mechanism includes a support portion disposed to extend in a radial direction away from the rotational axis. An arm portion is disposed to project from an end of the support portion, and extend in an axial direction of the rotational axis. The rotatable target object projects from an end of the arm portion.

The detecting device is secured to the support portion.

In one aspect of the invention, a photo film retention detecting method of detecting retention is provided, in which a trailer of photo film is picked up by an inserter, the inserter is rotationally inserted through a passageway of a cassette shell of a photo film cassette, and the trailer is fastened on a trailer fastener of a spool contained in the cassette shell. In the photo film retention detecting method, collimated light flux from a light source device applied to an opaque detecting device secured in a manner rotatable together with an inserter. Light is passed through a detection hole formed through the detecting device when openings at ends of the detection hole are aligned with one another in a direction of the collimated light flux. The passed light passed through the detection hole is received on a photo receptor, to output a detection signal according to an amount of the received passed light. An inserting amount of the inserter in the cassette shell is determined according to the detection signal, for evaluating propriety in retention of the trailer with the trailer fastener according to the inserting amount.

Also, a photo film retention detecting apparatus is provided, a photo film cassette including a cassette shell for containing a spool in a rotatable manner with a roll of photo film wound thereabout, a passageway, formed in the cassette shell, for passing the photo film, and a trailer fastener for fastening a trailer of the photo film on the spool. The photo film retention detecting apparatus includes an inserter for picking up the trailer of the photo film. A rotational driving mechanism rotates the inserter to insert through the passageway, and for retaining the trailer on the trailer fastener. An opaque detecting device is secured in a manner rotatable together with the inserter. A light source device applies collimated light flux to the detecting device. A detection hole is formed through the detecting device, for receiving application of the collimated light flux, and for passing light through the detection hole when openings at ends thereof are aligned with one another in a direction of the collimated light flux. A photo receptor receives the passed light passed through the detection hole, and for outputting a detection signal according to an amount of the received passed light, to detect rotation of the inserter. A determiner determines an inserting amount of the inserter in the cassette shell by acquiring a rotational position of the inserter, and for evaluating propriety in retention of the trailer with the trailer fastener.

The rotational driving mechanism includes a support portion disposed to extend in a radial direction away from the rotational axis. An arm portion is disposed to project from an end of the support portion, and extend In an axial direction of the rotational axis. The inserter projects from an end of the arm portion.

Furthermore, there is an actuator. A driving rod is slid by the actuator. A crank mechanism converts sliding of the driving rod into rotation, and for rotating the rotational driving mechanism.

The crank mechanism includes a movable transmission block secured to the driving rod. A cam pin is disposed to protrude from the transmission block. A rotatable transmission panel is secured to the inserter. A cam groove is formed in the transmission panel, having an inner cam surface, for receiving insertion of the cam pin, to rotating the transmission panel by pressure of the cam pin to the inner cam surface.

Furthermore, a pickup mechanism is disposed to project from an end of the inserter, for taking up the trailer of the photo film.

### BRIEF DESCRIPTION OF THE DRAWINGS

The above objects and advantages of the present invention will become more apparent from the following detailed description when read in connection with the accompanying drawings, in which:

FIG. 1 is a perspective view illustrating a photo film cassette;

FIG. 2 is a cross section illustrating the photo film cassette;

FIG. 3 is a perspective view illustrating a photo film winder;

FIG. 4 is a perspective view illustrating the photo film winder in a state of insertion:

FIG. 5 is an explanatory view in side elevation illustrating the photo film winder;

FIG. 6 is an explanatory view in side elevation illustrating the photo film winder of which an inserter picks up the photo film;

FIG. 7 is an explanatory view in side elevation illustrating the photo film winder in a state of insertion;

FIG. 8 is a block diagram illustrating the inserter for the photo film;

FIG. 9A Is a cross section, partially broken illustrating a relationship between the detection hole and infrared light;

FIG. 9B is an explanatory view in plan illustrating a projected state of infrared light;

FIG. 10 is a graph illustrating a relationship between an inclination angle and an area ratio;

FIG. 11 is a cross section, partially broken illustrating one preferred detection hole with different openings at ends;

FIG. 12 is a cross section, partially broken illustrating another preferred detection hole with modified inner surfaces;

FIG. 13 is an explanatory view in side elevation illustrating a known photo film winder;

FIG. 14A is a cross section illustrating a relationship between a spool and photo film in retention; and

FIG. 14B is a cross section illustrating a relationship of interference between the spool and photo film.

### DETAILED DESCRIPTION OF THE PREFERRED EMBODIMENT(S) OF THE PRESENT INVENTION

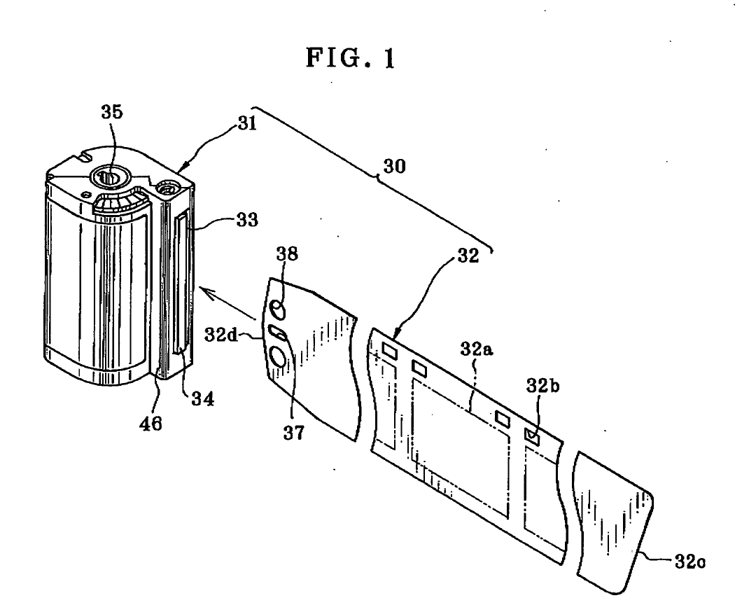

In FIG. 1, a photo film cassette 30 or cartridge is illustrated. The photo film cassette 30 is the IX 240 type, and includes a plastic cassette shell 31 or cartridge shell, and a photo film 32 contained in the cassette shell 31. When the photo film cassette 30 is not used, the photo film 32 inclusive of its leader is contained in the cassette shell 31. There is a passageway 33 for the photo film 32. A cassette shutter 34 closes the passageway 33. When a camera is loaded with the photo film cassette 30, the cassette shutter 34 Is rotated to open the passageway 33. A spool 35 is rotated in the photo film advancing direction. The photo film 32 advances to the outside of the cassette shell 31 through the passageway 33.

A number of image frames 32a are recordable on the photo film 32 which has a width of 24 mm. Two perforations 32b are formed in an edge portion of the image frames 32a and associated with each one of the image frames 32a. A leading end 32c of the photo film 32 has an inclined edge, which facilitates advance of the leading end 32c from the passageway 33 of the cassette shell 31. A trailing end 32d of the photo film 32 also has two inclined edges for facilitating insertion into a slot in the spool 35 of the cassette shell 31. There are an insertion hole 37 of a slot shape, and circular fastening holes 38.

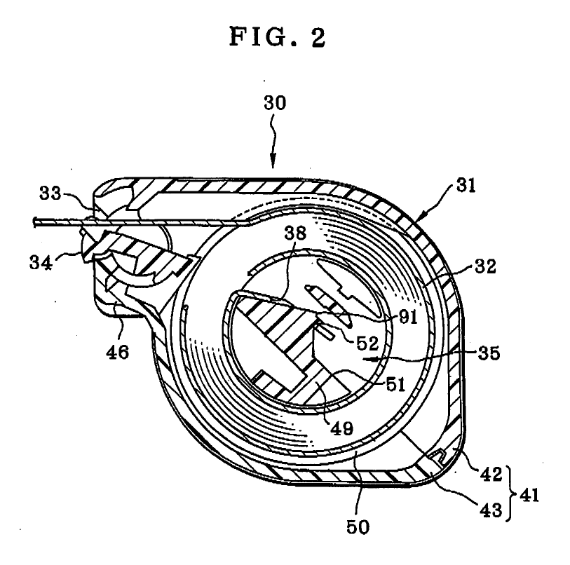

In FIG. 2, the photo film cassette 30 is illustrated in section. The cassette shell 31 includes a first shell half 42, a second shell half 43, the spool 35 and the cassette shutter 34. A shell wall 41 of the photo film cassette 30 is split in two to define the shell halves 42 and 43. The spool 35 and the cassette shutter 34 are contained between the shell halves 42 and 43 in a rotatable manner. Tongues 46 are formed with the shell halves 42 and 43 to protrude. The passageway 33 is defined between the tongues 46 for passing the photo film 32 into and out of the cassette shell 31.

A spool core 49 in the spool 35 has a rod shape. The photo film 32 is wound about the spool core 49. Flanges 50 of the spool 35 are formed on ends of the spool core 49, and contact and neaten ends of a roll of the photo film 32 about the spool core 49. A slot 51 is formed in the spool core 49 for insertion of the trailing end of the photo film 32. A hook shaped trailer fastener 52 is disposed inside the slot 51, and fastens the fastening holes 38 of the photo film 32. One end of the spool core 49 appears from an end face of the shell wall 41, and is rotated externally. The cassette shutter 34 is contained in the tongues 46 in a rotational manner for opening and closing the passageway 33. One end of the cassette shutter 34 appears from the and face of the shell wall 41, and is rotated externally.

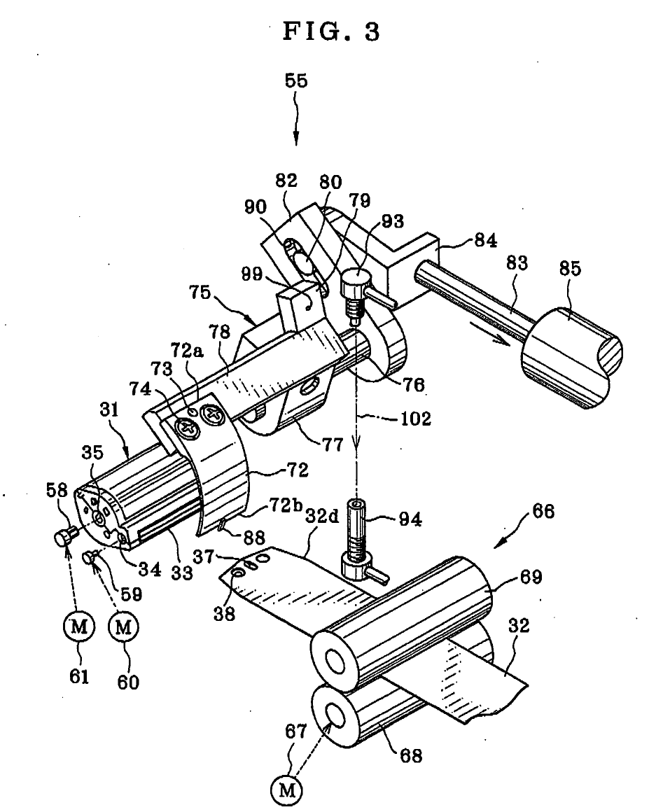

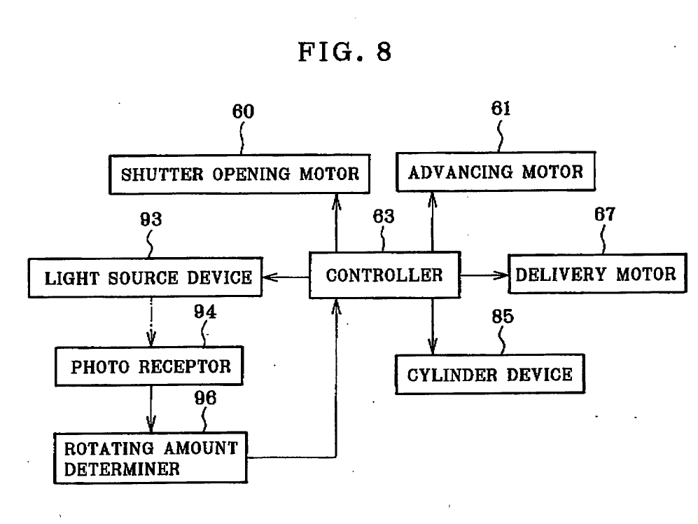

In FIGS. 3, 5 and 8, a photo film winder 55 or loader of the invention is illustrated. The cassette shell 31 after being assembled is fed to the photo film winder 55, and is kept positioned by a cassette holder (not shown). The spool 35 is kept to extend horizontally. The portion with the tongues 46 is set under the spool 35. The passageway 33 is directed up with an inclination.

A spool driving shaft 58 is engaged with the spool 35 in the end face of the cassette shell 31 in the cassette holder. A shutter driving shaft 59 is engaged with the cassette shutter 34 in the end face of the cassette shell 31. A shutter opening motor 60 drives the shutter driving shaft 59, and rotates the cassette shutter 34 between open and closed positions to open and close the passageway 33. An advancing motor 61 drives the spool driving shaft 58, and rotationally positions the spool 35 to direct openness the slot 51 to the passageway 33. The photo film 32 is rotated in the winding direction after retention of the photo film 32 to the spool 35. A controller 63 controls the shutter opening motor 60 and the advancing motor 61 among elements in the photo film winder 55.

A photo film delivery unit 66 is disposed In front of the cassette shell 31 supported by a support, and supplies the photo film 32 of a strip toward the cassette shell 31. The photo film delivery unit 66 includes a delivery motor 67, a capstan roller 68 for rotation, and a pinch roller 69. The capstan roller 68 is caused by the delivery motor 67 to rotate in a forward direction. The pinch roller 69 is rotatable in a manner of a follower, and nips the photo film 32 In cooperation with the capstan roller 68. There are a photo film roll, a perforation forming device, and a cutter. The photo film roll is positioned upstream from the photo film delivery unit 66 in the supply direction, and is a roll of photo film of a great length. The perforation forming device forms the perforations 32b in the photo film unwound from the photo film roll. The cutter cuts the photo film, and works portions of the photo film to obtain the leading end 32c and the trailing end 32d.

A rotatable inserter 72 as a rotatable target object is disposed higher than the passageway 33 of the cassette shell 31, and consists of a thin plate of metal flexed in an arc shape. The inserter 72 has a rear end 72a. There is an arm fitted rotational driving mechanism 75. Two screws 74 fasten the rear end 72a on the rotational driving mechanism 75. Furthermore, a positioning pin 73 can be added to secure the inserter 72 in a precisely positioned manner. The rotational driving mechanism 75 includes a hub shaped support portion 77, an arm portion 78, and a blade or detecting dog device 79. A pivotal rod 76 extends in parallel with the spool 35. The hub shaped support portion 77 is secured to one end of the pivotal rod 76 and rotates together. The arm portion 78 extends in the axial direction of the pivotal rod 76 with reference to the hub shaped support portion 77. The dog device 79 to protrude for photo interruption in motion sensing is disposed on the outside of the hub shaped support portion 77 and formed from metal. The inserter 72 is fitted on an end of the arm portion 78 and kept oriented in the arc shape which is defined rotationally about the center of the hub shaped support portion 77.

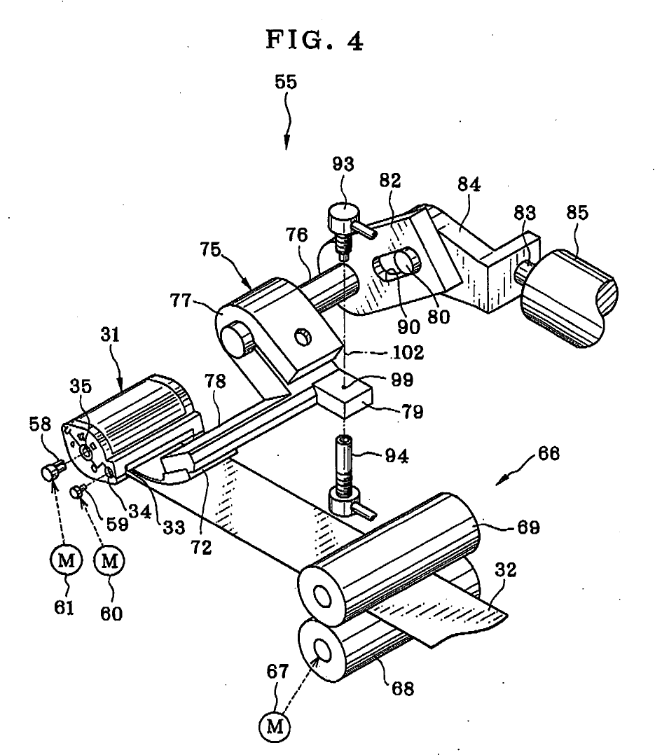

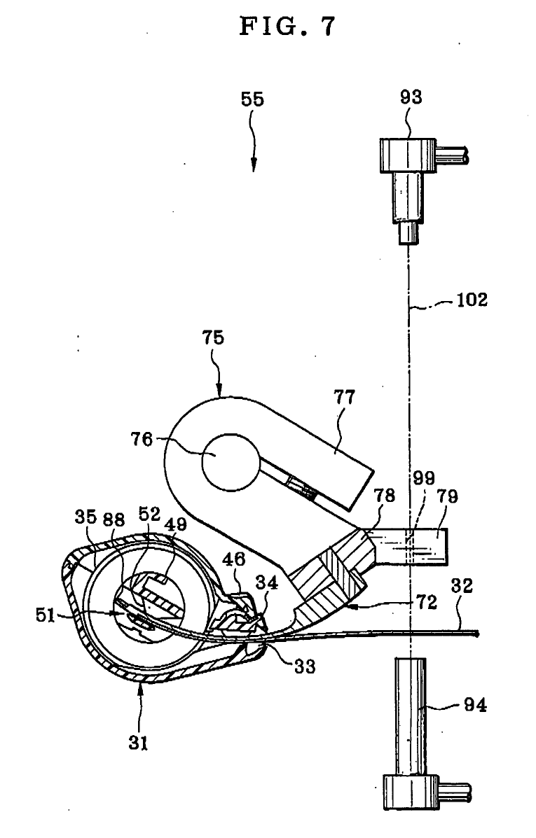

A support (not shown) supports the pivotal rod 76 In a rotatable manner. A transmission panel 82 for linking has one end secured to a second end of the pivotal rod 76. A transmission block or bracket 84 is secured to an end of a slidable driving rod 83. The transmission block 84 is secured to a second end of the transmission panel 82 in a rotatable manner. When a cylinder device 85 as actuator slides the driving rod 83 in the arrow direction, a cam pin 80 and a cam groove 90 cooperate to convert the sliding into a rotational movement, which is transmitted to the pivotal rod 76. The pivotal rod 76 causes the rotational driving mechanism 75 to rotate in the clockwise direction. In FIGS. 4 and 7, the rear end 72a of the inserter 72 is inserted in the passageway 33 of the cassette shell 31.

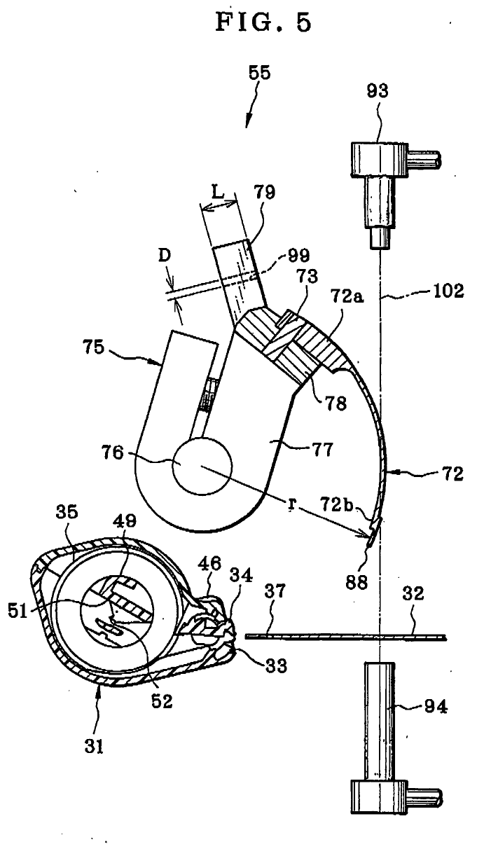

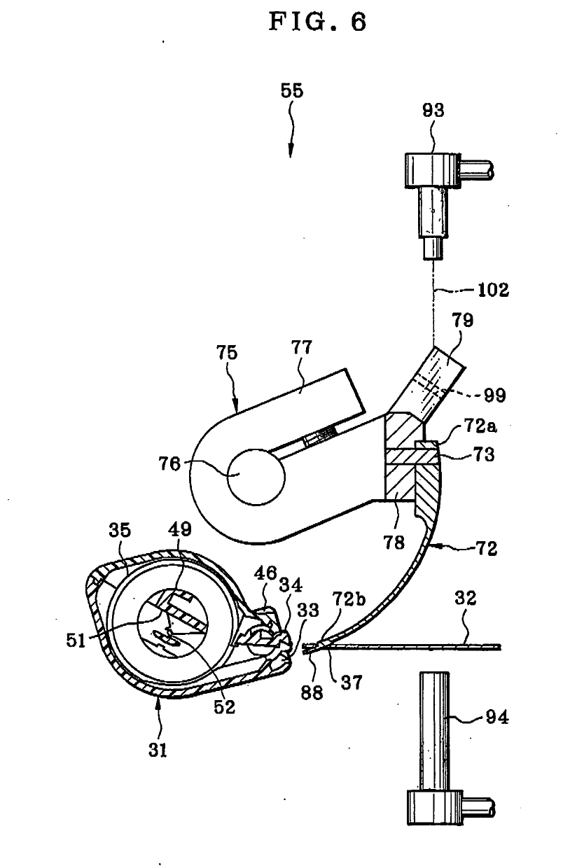

The inserter 72 is caused by rotation of the transmission panel 82 to rotate between a reference position of FIGS. 3 and 5 and a retention position of FIGS. 4 and 7. The reference position is a position where the inserter 72 is out of the passageway 33. The cassette shell 31 is set into or out of a cassette holder while the inserter 72 is in the reference position. A pickup claw 88 is formed with the rear end 72a of the inserter 72 for insertion in the insertion hole 37 of the photo film 32 in rotation from the reference position to the retention position as depicted in FIG. 6. The insertion hole 37 is engaged with the, pickup claw 88 to pick up and insert the photo film 32 into the cassette shell 31 together with the inserter 72. The trailing end 32d of the photo film. 32 is inserted by the inserter 72 in the slot 51 of the spool 35, to fasten the fastening holes 38 to the trailer fastener 52. After the insertion of the photo film 32, the inserter 72 is rotated to the reference position by the driving rod 83, and is removed from the cassette shell 31.

When the trailer of the photo film 32 is retained on the spool 35, the photo film delivery unit 66 inspects the photo film 32 as a test related to tension. In the test, load is applied to the photo film 32 in a direction of advance from the cassette shell 31, to check engagement of the fastening holes 38 with the trailer fastener 52. The delivery motor 67 rotates in reverse, to apply load to the photo film 32 by use of the capstan roller 68. After the test, the spool 35 is rotated in the winding direction, to wind the photo film 32 into the cassette shell 31. The photo film cassette 30 as a product is obtained.

In the course of production, a mold for the spool 35 is likely to form a ridge with flash 91 of plastic on a parting line. It is likely that an erroneously successful result is obtained in inspection of tension, because the fastening holes 38 of the photo film 32 in the photo film winder 55 may interfere with the ridge with flash 91. In order to prevent such an error, a rotating amount of the inserter 72 is detected in retaining the trailing end 32d of the photo film 32 on the spool 35 with the inserter 72. An amount of the insertion of the photo film 32 to the slot 51 is detected, to check acceptability of retention of the fastening holes 38 on the trailer fastener 52. To detect a rotating amount of the inserter 72, the blade or detecting dog device 79 is used. Also, a combination of a light source device 93 with a collimator and a photo receptor 94 or photo sensor is installed with the blade or detecting dog device 79. A rotating amount determiner 96 is connected with the controller 63, to determine a rotating amount of the inserter 72 by receiving a detection signal of the photo receptor 94.

The blade or detecting dog device 79 is a piece of metal with a thickness L of 5 mm. A detection through hole 99 of a tunnel type is formed to come through the dog device 79 in a direction perpendicular to the pivotal rod 76. A shape of the detection hole 99 is a circle with a diameter D of 0.5 mm. When the inserter 72 is rotated in a direction for insertion in the cassette shell 31, the detection hole 99 is exactly opposed to collimated light flux emitted by the light source device 93. Examples of methods of forming the detection hole 99 are perforating by drilling, electromachining by discharge, and the like. Inner surfaces of the detection hole 99 have high surface roughness, to prevent reflection of light. It is possible to process the inside of the detection hole 99 in anti-reflection processing additionally.

Infrared light 102 or collimated light flux for detection is emitted by the light source device 93, and directed downwards from the light source device 93 disposed higher than the rotational driving mechanism 75. An area of the flux of the infrared light 102 is larger than an area of the section of the detection hole 99, but is smaller than an area of a surface of the blade or detecting dog device 79 having the detection hole 99. The photo receptor 94 is opposed to the light source device 93 and disposed lower then the rotational driving mechanism 75, receives the infrared light 102 from the light source device 93, and outputs a detection signal according to a light amount of received light, to send the detection signal to the rotating amount determiner 96.

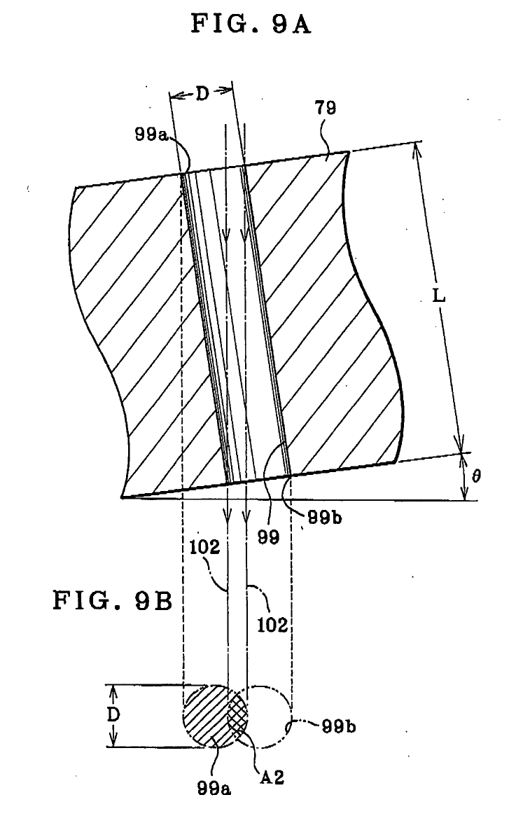

In FIG. 9A, a relationship between the infrared light 102 from the light source device 93 and the detection hole 99 in the blade or detecting dog device 79 is depicted. While the rotational driving mechanism 75 rotates from the reference position of the inserter 72 to its retention position, the dog device 79 is inserted in an illuminating range of the infrared light 102, to intercept entry of the infrared light 102 to the photo receptor 94. The rotational driving mechanism 75 further rotates. In FIG. 9B, a first opening or orifice 99a of the detection hole 99 becomes aligned with a second opening or orifice 99b. The infrared light 102 passes through the detection hole 99 and enters the photo receptor 94, which outputs a detection signal according to a light amount of incident light with a limited profile. When the detection hole 99 is oriented in parallel with the direction of the infrared light 102 during rotation of the rotational driving mechanism 75, the first and second openings 99a and 99b are exactly positioned in an aligned manner. A light amount of the infrared light 102 passed through the detection hole 99 is maximal.

If a detection signal from the photo receptor 94 is in a predetermined range of the level, the rotating amount determiner 96 determines that the inserter 72 has rotated to come to a suitable rotational position, namely determines that the inserter 72 has become inserted in the slot 51 in the predetermined position, for suitable retention of the fastening holes 38 of the photo film 32 on the trailer fastener 52. If a detection signal from the photo receptor 94 is not in the predetermined range of the level, the rotating amount determiner 96 determines occurrence of an error in retention of the fastening holes 38 of the photo film 32 on the trailer fastener 52. Information of the result in the rotating amount determiner 96 is sent to the controller 63 and used in managing products. To remove a product with an error in suitable fastening of the trailing end 32d of the photo film 32 to the spool 35, the result of the rotating amount determiner 96 can be used and evaluated.

A level of the detection signal of a rotational amount of the inserter 72, detected acceptable by the rotating amount determiner 96, is predetermined. For example, the level is according to the ratio A3=A2/A1, where A1 is an aperture area of the first opening 99a of the detection hole 99, and A2 is an area of a superposed region of the first and second openings 99a and 99b by alignment in the traveling direction of the infrared light 102. In the embodiment, the reference level is the detection signal S at the time that the ratio A3 is 0.5. If the detection signal input by the photo receptor 94 is equal to or more than the detection signal S, then the engagement between the fastening holes 38 and the trailer fastener 52 is judged as acceptable.

A depth or size L of the detection hole 99 in the penetrating direction is 5 mm. A diameter or width D of the detection hole 99 is 0.5 mm. An inclination angle θ of the blade or detecting dog device 79 when the area ratio A3 is 0.5 is approximately 2.3 degrees with reference to a state where a penetrating direction of the detection hole 99 extends in parallel with the infrared light 102. If a rotational radius r of the pickup claw 88 of the inserter 72 is 25 mm, a moving amount, which is in the direction of the periphery of the pickup claw 88 and obtained by conversion of an inclination angle θ, is approximately 1 mm. It is possible in the embodiment to detect a moving amount of the pickup claw 88 in a range of 1 mm, so engagement of the fastening holes 38 with the trailer fastener 52 can be monitored precisely. An area ratio A3 changes from zero (0) to one (1) by rotation of the rotational driving mechanism 75, and further changes from one (1) to zero (0) in rotation of the rotational driving mechanism 75. In the embodiment, the rotational section of the area ratio A3 from zero (0) to one (1) is used for the detection. However, the entirety of the sections from zero (0) to one (1) and from one (1) to zero (0) can be utilized instead.

The operation of the above embodiment is illustrated. The cassette shell 31 of plural parts is delivered to the photo film winder 55 and set in a cassette holder. On an end face of the cassette shell 31, the spool driving shaft 58 and the shutter driving shaft 59 are respectively engaged with the spool 35 and the cassette shutter 34. The controller 63 causes the shutter opening motor 60 and the advancing motor 61 to rotate, to open the passageway 33. Also, the slot 51 of the spool 35 is controlled and oriented toward the passageway 33.

The controller 63 causes the delivery motor 67 to rotate forwards. The capstan roller 68 and the pinch roller 69 are rotated to supply the photo film 32. Then the cylinder device 85 is driven to retract the driving rod 83 by sliding, to rotate the transmission panel 82. The rotational driving mechanism 75 is caused by the pivotal rod 76 to rotate, to insert the inserter 72 in the passageway 33. In the course of the insertion, the pickup claw 88 is engaged with the insertion hole 37, to insert the photo film 32 with the cassette shell 31.

During the rotation, the blade or detecting dog device 79 comes in a path of the infrared light 102 between the light source device 93 and the photo receptor 94. When the rotational driving mechanism 75 rotates further, the detection through hole 99 reaches the infrared light 102, to align the first and second openings 99a and 99b with one another. The infrared light 102 passes the detection hole 99 and becomes incident on the photo receptor 94 with a limited profile, so a detection signal of a light amount is sent to the rotating amount determiner 96. When the ratio A3=A2/A1 comes up and becomes equal to 0.5, then the rotating amount determiner 96 determines that the inserter 72 has made rotation of a predetermined amount, where A1 is an aperture area of the first opening 99a of the detection hole 99, and A2 is an area of a superposed region of the first and second openings 99a and 99b by alignment in the traveling direction of the infrared light 102. A result of the determination is input to the controller 63. The controller 63 records the result, and utilizes the information for management.

Consequently, rotation of the inserter 72 can be detected by the blade or detecting dog device 79, the light source device 93 and the photo receptor 94. The detection is possible at a considerably low cost. A moving position of the pickup claw 88 can be detected in a range of 1 mm, to detect engagement exactly between the fastening holes 38 and the hook shaped trailer fastener 52.

### EXAMPLE

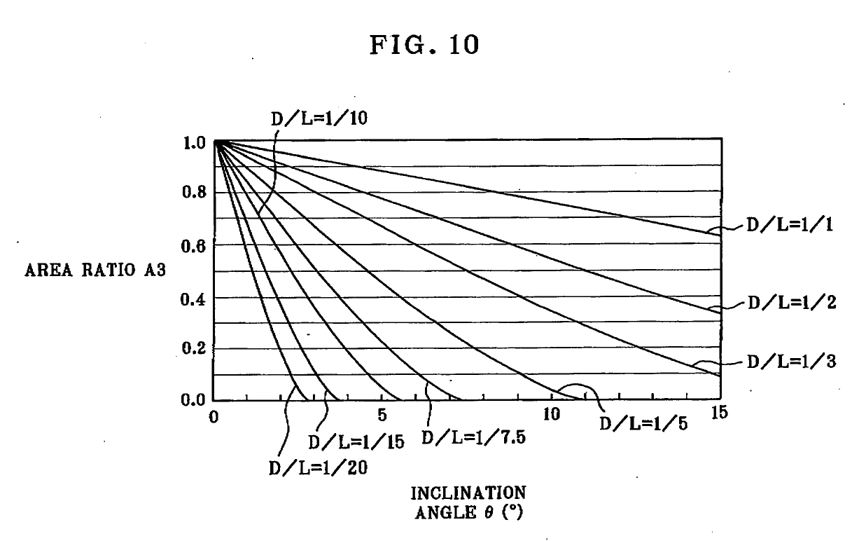

In the above embodiment, the diameter or width D of the detection through hole 99 is 0.5 mm. The depth or size L is 5 mm. A ratio D/L is 1/10. In FIG. 10, a relationship is indicated in a graph between the area ratio A3 and the inclination angle θ of the detection hole of a tunnel type when the ratio D/L is from 1/1 to 1/20. When the ratio D/L is 1/1, sensitivity of detection is low, because the area ratio A3 is changeable very slightly relative to a change in the inclination angle θ. When the ratio D/L is 1/20, sensitivity of detection is high. However, a range of detection is small because the area ratio A3 does not change when the inclination angle θ is 3 degrees or so.

It has been found that a value of the D/L ratio over 1/1 is unsuitable due to too low detection sensitivity, and a value of the D/L ratio under 1/20 is unsuitable due to too small a range of detection. If the D/L ratio is under 1/20, the diameter D will be too small without enlarging the depth or size L. No through hole can be formed easily. If the depth L is too great, a small apparatus cannot be constructed by utilizing the invention. Thus, the ratio D/L between the diameter D and depth L of the detection hole 99 is in a preferable range from 1/1 to 1/20. It is possible suitably to determine the ratio D/L according to a desired angle range of detection and the detection sensitivity.

In the embodiment, it is determined that the inserter 72 has made rotation of a predetermined amount when the area ratio A3 becomes equal to 0.5. However, the area ratio A3 can be predetermined in various manners selectively for practical use. However, if the area ratio A3 is near to zero (0), the S/N ratio is exceedingly low, so a level of a detection signal output by the photo receptor will be as low as a level of electrical noise. The area ratio A3 can be practically equal to or more than 0.1, preferably equal to or more than 0.3, and desirably equal to or more than 0.5. Table 1 below indicates values of the inclination angle θ at the time that the area ratio A3 is 0.3 or 0.5 and D/L is in a range of 1/1 to 1/20. It Is possible with the D/L ratio to balance the angle range and the detection sensitivity acceptably by referring to the values in the inclination angle θ of Table 1.

TABLE 1

| | Area ratio 0.5 | Area ratio 0.3 |
|---|---|---|
| D/L | Angle θ | Angle θ |
| 1/1 | 20.35 | 28.09 |
| 1/2 | 11.14 | 15.75 |
| 1/3 | 7.56 | 10.77 |
| 1/5 | 4.61 | 6.62 |
| 1/7.5 | 3.07 | 4.40 |
| 1/10 | 2.31 | 3.34 |
| 1/15 | 1.54 | 2.23 |
| 1/20 | 1.16 | 1.67 |

In the above embodiment, the detection hole of a tunnel type is circular. However, a shape of a detection hole of a tunnel type can be in any suitable form, for example, a polygonal form with three sides or more, an elliptical form, a slot form, or the like. In FIG. 11, another preferred detection hole 110 of a tunnel type is illustrated. A first opening or orifice 110a has a smaller size than a second opening or orifice 110b. It is preferable that the first opening 110a having a smaller first length in the radial direction of the rotational orbit of the detection hole 110 is used as a reference. The smaller first length is used as the length D1 so that the ratio D/L can be obtained.

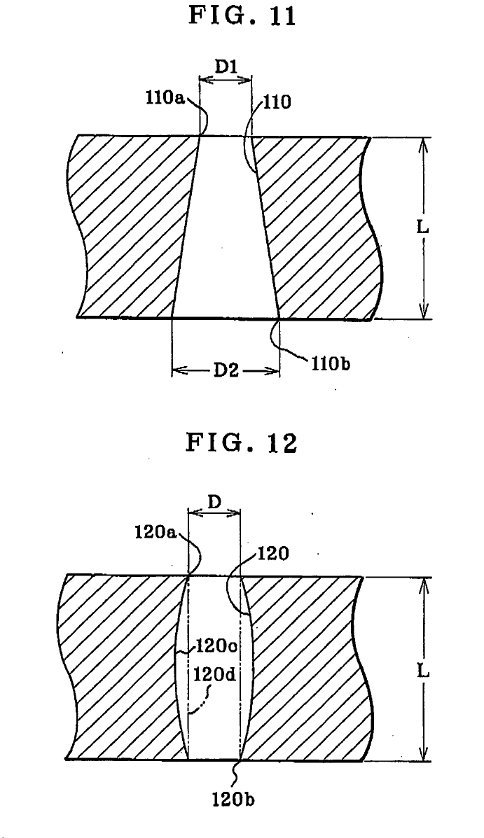

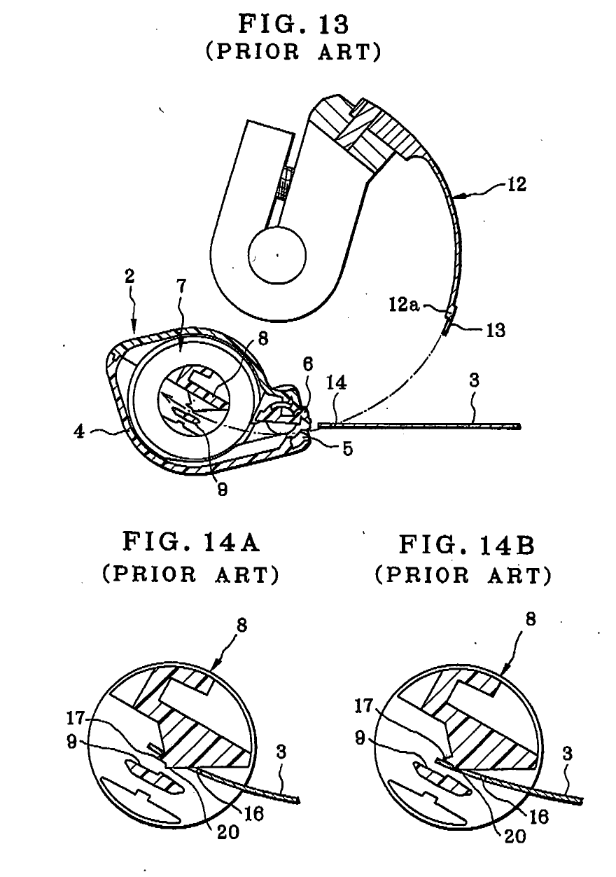

In FIG. 12, another preferred detection hole 120 of a tunnel type is illustrated, in which inner surfaces are offset from a direction of the illuminating detection light. A virtual surface 120d is defined by straight lines passing ends of a first opening or orifice 120a and a second opening or orifice 120b. Inner surfaces 120c of the detection hole 120 are curved and spread in an offset manner from the virtual surface 120d, and allow passage of detection light without blocking.

In the above embodiment, the detecting hole is single. However, a plurality of detecting holes may be formed. Also, a plurality of sets of the light source device and photo receptor may be disposed to detect the detecting hole. Instead of using the blade or detecting dog device 79, the detecting hole can be formed in the pivotal rod 76 in the radial direction as a through hole detectable for detecting rotation of the inserter 72. A rotation detection of the invention may be used in any suitable devices other than the photo film winder.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A rotation detecting method comprising steps of:
applying collimated light flux from a light source device to an opaque detecting device secured in a manner rotatable together with a rotatable target object;
while said collimated light flux is applied, passing light of said collimated light flux through a detection hole formed through said detecting device when openings at ends of said detection hole are aligned with one another in a direction of said collimated light flux; and
receiving said passed light on a photo receptor, to output a detection signal according to an amount of said received passed light.

2. A rotation detecting method as defined in claim 1, wherein a length of said detection hole in a thickness direction of said detecting device is larger than a width of said openings in a rotational direction thereof.

3. A rotation detecting method as defined in claim 2, further comprising a step of determining a rotational amount of said rotatable target object according to said detection signal.

4. A rotation detecting method as defined in claim 3, wherein a ratio D/L of said width to said length is in a range less than 1/1 and equal to or more than 1/20.

5. A rotation detecting apparatus comprising:
an opaque detecting device secured in a manner rotatable together with a rotatable target object;
a light source device for applying collimated light flux to said detecting device;
a detection hole, formed through said detecting device, for receiving application of said collimated light flux, and for passing light of said collimated light flux through said detection hole when openings at ends thereof are aligned with one another in a direction of said collimated light flux; and
a photo receptor for receiving said passed light, and for outputting a detection signal according to an amount of said received passed light.

6. A rotation detecting apparatus as defined in claim 5, wherein a length of said detection hole in a thickness direction of said detecting device is larger than a width of said openings in a rotational direction thereof.

7. A rotation detecting apparatus as defined in claim 6, wherein said openings at said ends have respectively first and second widths, and said width is a smaller one of said first and second widths.

8. A rotation detecting apparatus as defined in claim 6, wherein a ratio D/L of said width to said length is in a range less than 1/1 and equal to or more than 1/20.

9. A rotation detecting apparatus as defined in claim 8, further comprising a rotating amount determiner for determining a rotating amount of said rotatable target object according to said detection signal.

10. A rotation detecting apparatus as defined in claim 9, wherein said rotating amount determiner determines said rotating amount with said detection signal of a state when an area ratio A2/A1 is 0.1 or more, where A1 is an area of said openings having said width, and A2 is an area of an open region defined by superposing said openings in said illuminating direction of said collimated light flux.

11. A rotation detecting apparatus as defined in claim 10, wherein said area of said openings is smaller than an area of a section of said collimated light flux on a perpendicular plane thereof.

12. A rotation detecting apparatus as defined in claim 10, wherein an inner surface of said detection hole is formed to extend along a plane that is defined to pass peripheral ends of said openings, or is formed to retreat from said plane.

13. A rotation detecting apparatus as defined in claim 10, wherein an inner surface of said detection hole is processed by anti-reflection processing optically to prevent reflection.

14. A rotation detecting apparatus as defined in claim 10, wherein said collimated light flux is infrared.

15. A rotation detecting apparatus as defined in claim 5, wherein said rotatable target object is formed in an arc shape to extend along a cylindrical surface defined about a rotational axis, and is rotated by a rotational driving mechanism for rotating about said rotational axis.

16. A rotation detecting apparatus as defined in claim 15, wherein said rotational driving mechanism includes:
a support portion disposed to extend in a radial direction away from said rotational axis;
an arm portion, disposed to project from an end of said support portion, and extend in an axial direction of said rotational axis;
wherein said rotatable target object projects from an end of said arm portion.

17. A rotation detecting apparatus as defined in claim 16, wherein said detecting device is secured to said support portion.

18. A photo film retention detecting method of detecting retention in which a trailer of a photo film is inserted in a spool by rotation of an inserter through a passageway formed in a cassette shell, and said trailer picked up by said inserter is retained on said spool in said cassette shell, said photo film retention detecting method comprising steps of:
applying collimated light flux from a light source device to an opaque detecting device secured in a manner rotatable together with an inserter;
while said collimated light flux is applied, passing light of said collimated light flux through a detection hole formed through said detecting device when openings at ends of said detection hole are aligned with one another in a direction of said collimated light flux;
receiving said passed light on a photo receptor, to output a detection signal according to an amount of said received passed light; and
determining an inserting amount of said inserter in said cassette shell according to said detection signal, for evaluating propriety in retention of said trailer with said trailer fastener according to said inserting amount.

19. A photo film retention detecting apparatus for a photo film cassette including a spool having a trailer fastener for fastening a trailer of photo film, a cassette shell for containing said spool in a rotatable manner, and a passageway, formed in said cassette shell, for passing said photo film, said photo film retention detecting apparatus comprising;
an inserter for picking up said trailer of said photo film;
a rotational driving mechanism for rotating said inserter to insert through said passageway, and for retaining said trailer on said trailer fastener;
an opaque detecting device secured in a manner rotatable together with said inserter;
a light source device for applying collimated light flux to said detecting device;
a detection hole, formed through said detecting device, for receiving application of said collimated light flux, and for passing light of said collimated light flux through said detection hole when openings at ends thereof are aligned with one another in a direction of said collimated light flux;
a photo receptor for receiving said passed light, and for outputting a detection signal according to an amount of said received passed light, to detect a rotating amount of said inserter; and
a determiner for determining an inserting amount of said inserter in said cassette shell according to said rotating amount, and for evaluating propriety in retention of said trailer with said trailer fastener.

20. A photo film retention detecting apparatus as defined in claim 19, wherein a length of said detection hole in a thickness direction of said detecting device is larger than a width of said openings in a rotational direction thereof.

21. A photo film retention detecting apparatus as defined in claim 20, wherein said inserter is formed in an arc shape to extend along a cylindrical surface defined about a rotational axis, and said rotational driving mechanism rotates about said rotational axis.

22. A photo film retention detecting apparatus as defined in claim 21, wherein a ratio D/L of said width to said length is in a range less than 1/1 and equal to or more than 1/20.

23. A photo film retention detecting apparatus as defined in claim 22, wherein said rotational driving mechanism includes:
a support portion disposed to extend in a radial direction away from said rotational axis;
an arm portion, disposed to project from an end of said support portion, and extend in an axial direction of said rotational axis;
wherein said inserter projects from an end of said arm portion.

24. A photo film retention detecting apparatus as defined in claim 23, wherein said detecting device is secured to said support portion.

25. A photo film retention detecting apparatus as defined in claim 23, further comprising:
an actuator;
a driving rod for being slid by said actuator; and
a crank mechanism for converting sliding of said driving rod into rotation, and for rotating said rotational driving mechanism.

26. A photo film retention detecting apparatus as defined in claim 23, further comprising a pickup mechanism, disposed to project from an end of said inserter, for taking up said trailer of said photo film.
